(19) United States
(12) Patent Application Publication
(10) Pub. No.: US 2011/0175565 A1
(43) Pub. Date: Jul. 21, 2011

(54) ENERGY STORAGE SYSTEM AND METHOD OF CONTROLLING THE SAME

(75) Inventor: Sung-Im LEE, Suwon-si, (KR)

(73) Assignee: SAMSUNG SDI CO., LTD., Yongin-si (KR)

(21) Appl. No.: 12/845,866

(22) Filed: Jul. 29, 2010

(30) Foreign Application Priority Data
Jan. 21, 2010 (KR) 10-2010-0005749

(51) Int. Cl. H01M 10/46; H02J 7/00

(52) U.S. Cl. 320/101; 320/128; 320/134

(57) ABSTRACT

An energy storage system that prevents overshoot or undershoot at a node that transfers power when an operational mode of the energy storage system is converted or when a state of a power consuming element is changed, and a method of controlling the energy storage system.

### CLAIM OF PRIORITY

This application makes reference to, incorporates the same herein, and claims all benefits accruing under 35 U.S.C. §119 from an application filed in the Korean Intellectual Property Office on the 21^{st} of Jan. 2010 and there duly assigned Serial No. 10-2010-0005749.

### BACKGROUND OF THE INVENTION

1. Field of the Invention

The general inventive concept relates to an energy storage system and to a method of controlling the energy storage system.

2. Description of the Related Art

As environmental problems, such as environment destruction and exhaustion of resources, become more apparent, systems able to store power and efficiently use the stored power are receiving increased attention. Also, the significance of renewable energy sources, such as solar energy generation, is increasing. In particular, renewable energy is generated by using effectively limitless natural resources such as solar energy, wind power, tidal power, etc. and does not cause pollution during the generation process. Recently, a smart grid system, which is a system for optimizing energy efficiency, has been developed by two-way exchange of information between an electricity supplier and a consumer.

The above information disclosed in this Related Art section is only for enhancement of understanding of the background of the invention and therefore it may contain information that does not form the prior art that is already known to a person of ordinary skill in the art.

### SUMMARY OF THE INVENTION

One or more aspects of the present invention may include an energy storage system and a method of controlling the energy storage system, wherein problems that may result in elements of the energy storage system becoming damaged are prevented, as balance between a power supply source and a power consuming element is lost when an operational mode of the energy storage system is converted or when a state of the power consuming elements is changed.

Additional aspects will be set forth in part in the description which follows and, in part, will be apparent from the description, or may be learned by practice of the presented embodiments.

According to one or more aspects of the present invention, an energy storage system includes a power converter that converts electrical power supplied from a generation module to a first voltage and outputs the first voltage to a first node; a battery that receives electrical power from the generation module or from an electric power system to charge the battery and discharges the power to the electric power system or a load; a two-way converter that converts a voltage level of the power stored in the battery to the first voltage and outputs the power converted by the two-way converter, and converts the voltage level of the power input from the first node to output electrical power to the battery. A two-way inverter inverts the power output from the electric power system to the first voltage and outputs the first voltage to the first node, and inverts the power input from the first node to output the power to the load or the electric power system. A integrated controller that controls operations of the power converter, the battery, the two-way converter, and the two-way inverter, wherein when an operational mode of the energy storage system is converted, the integrated controller restricts an output power variation rate of at least one of the power converter, the two-way converter, and the two-way inverter.

The energy storage system may restrict an output power variation rate across the first node during conversion of the operational mode of the energy storage system. To this end, the integrated controller may include a mode controlling unit that controls an operational mode of the energy storage system; and a stable initiation control unit that restricts, when a power supply element to the first node is changed according to a change in the operational mode of the energy storage system, an output power variation rate of a new power supply element to be a restriction value or less.

The energy storage system may restrict an output power variation rate across the first node when a state of the power consuming element is changed. To this end, the integrated controller may include a power consuming element monitoring unit that senses a change in a power consuming element that receives power through the first node or a change in a state of the power consuming element; and a stable initiation control unit that restricts, when a power supply element is changed or when a change in the state of the power consuming element is sensed, an output power variation rate of a new power supply element to be a restriction value or less.

The energy storage system may restrict the output power variation rate until the first node reaches a normal state. To this end, the integrated controller may include a first node monitoring unit that senses a voltage of the first node; and a normal state maintaining unit that maintains a power supply of a power supply element of the first node in a normal state when the voltage across the first node reaches a normal state voltage.

The integrated controller may restrict an output power variation rate of a power supply element of the first node in a time period that is determined in advance.

Also, to restrict the output power variation rate, the integrated controller may maintain the output power variation rate at a value that is determined in advance when restricting the output power variation rate.

The integrated controller may control the power supply element of the first node so as to reduce the output power variation rate when the output power variation rate rises to, or beyond, a value determined in advance when restricting the output power variation rate.

When the battery is initially and newly coupled to the energy storage system as a new power supply source of the first node, the integrated controller may control at least one of the battery and the two-way converter so as to restrict a variation rate of an output current that is output from the two-way converter to the first node.

When the electric power system is initially and newly coupled to the energy storage system as a new power supply source, the integrated controller may control the two-way inverter to restrict a variation rate of an output current that is output to the first node through the two-way inverter from the electric power system.

The generation module may be a solar battery, and the power converter may be a maximum power point track (MPPT) converter, and when the solar battery is initially and newly coupled to the energy storage system as a new power supply source, the integrated controller may control the MPPT converter to restrict an operational voltage variation rate of the MPPT converter, and when the first node reaches a normal state, the integrated controller may control the MPPT converter to track a maximum power output voltage.

The battery may be removably connected and detachably mounted in the energy storage system.

According to one or more aspects of the present invention, a method of controlling an energy storage system, wherein the energy storage system supplies power that is supplied from a generation module to a battery, a load, or an electric power system via a first node, and supplies the power charged to the battery to the load or the electric power system via the first node, and supplies the power supplied from the electric power system to the load or the battery via the first node, by controlling an operational mode of the energy storage system; and restricting an output power variation rate of a power supply source of the first node when the operational mode of the energy storage system is changed.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic view illustrating an energy storage system constructed as an embodiment of the present invention;

FIG. 2 is a flowchart illustrating power and a control signal of the energy storage system of FIG. 1;

FIG. 3 is a graph illustrating a relationship between a solar battery voltage and a solar battery output power according to solar irradiance;

FIG. 4 is a schematic view illustrating an integrated controller constructed as an embodiment of the present invention;

FIGS. 5A and 5B are schematic views illustrating an operational mode conversion of an energy storage system according to the principles of the present invention;

FIGS. 6A through 6C are schematic views illustrating an operational mode conversion of an energy storage system according to the principles of the present invention;

FIG. 7 is a flowchart illustrating a method of controlling an energy storage system according to an embodiment of the present invention; and

FIG. 8 is a flowchart illustrating a method of controlling an energy storage system according to another embodiment of the present invention.

### DETAILED DESCRIPTION OF THE INVENTION

Hereinafter, preferred embodiments of the present invention will now be described with reference to the attached drawings, and parts of the embodiments of the present invention that may be easily implemented by one of ordinary skill in the art may be omitted.

Also, the specification and the drawings of the embodiments of the present invention should not be construed as limiting the scope of the present invention but the scope of the present invention should be defined by the appended claims. The meaning of the terms used in the present specification and claims of the present invention should be construed as meanings and concepts not departing from the spirit and scope of the invention based on the principle that the inventor is capable of defining concepts of terms in order to describe the invention in the most appropriate way.

As those skilled in the art would realize, the described embodiments may be modified in various different ways, all without departing from the spirit or scope of the principles for the present invention.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. Alternatively, when an element is referred to as being “directly on” another element, there are no intervening elements present.

In order to clarify the present invention, elements extrinsic to the description may be omitted from the details of this description, and like reference numerals refer to like elements throughout the specification.

In several exemplary embodiments, constituent elements having the same configuration are representatively described in a first exemplary embodiment by using the same reference numeral and only constituent elements other than the constituent elements described in the first exemplary embodiment will be described in other embodiments.

The present invention will now be described more fully with reference to the accompanying drawings, in which exemplary embodiments of the invention are shown.

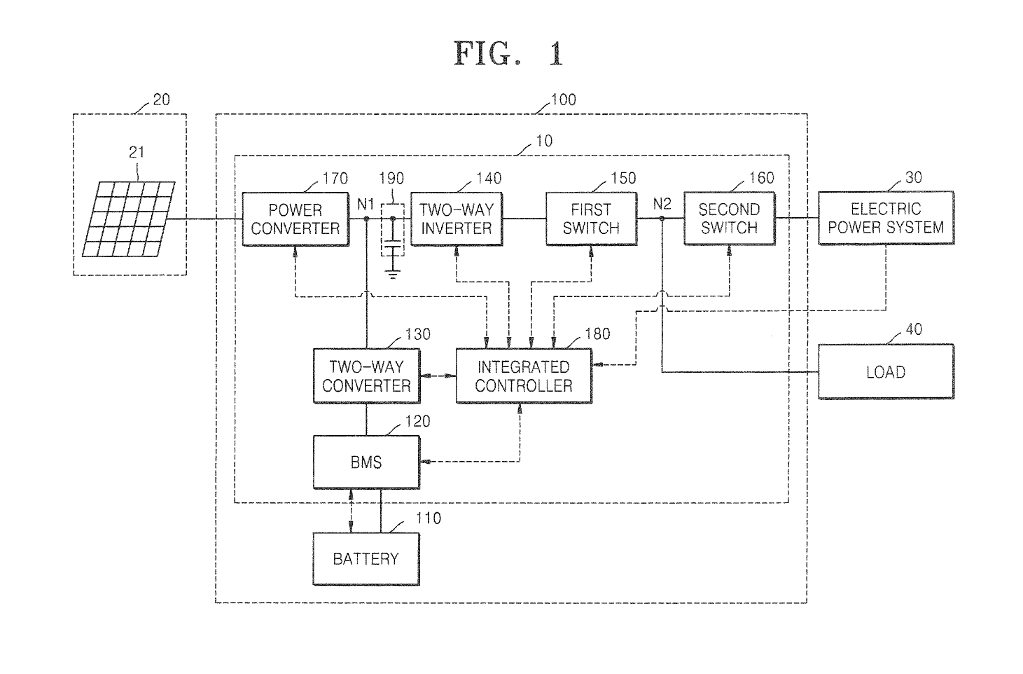

FIG. 1 is a schematic view illustrating an energy storage system 100 constructed as an embodiment of the present invention.

Referring to FIG. 1, energy storage system 100 includes a generation module 20 that generates electric energy, an electric power system 30 that transfers the electric energy, a power storage device 10 that outputs stored power to a load 40 or the electric power system 30, and the load 40 that receives the power from the power storage device 10 or the electric power system 30 and consumes the power. The battery 110 may be integrated with the power storage device 10 or alternatively, may be separated.

The electric power system 30 includes a power plant, a substation, transmission lines, or the like, and transmits power to the load 40 connected to the electric power system 30. In a normal state, the electric power system 30 supplies power to the power storage device 10 or the load 40, and receives the power supplied from the power storage device 10 and transmits the power to elements connected to the electric power system 30. If the electric power system 30 is not in a normal state due to, for example, a power outage or electric work being carried out, power supply from the electric power system 30 to the power storage device 10 or the load 40 is stopped, and power supply from the power storage device 10 to the electric power system 30 is also stopped.

The generation module 20 generates electric energy and outputs the same to the power storage device 10. The generation module 20 may generate electric energy by using renewable energy such as solar heat, solar light, wind power, tidal power, geothermal heat, or the like. In particular, solar batteries that generate electric energy by using solar light are easy to install in homes or factories, and thus are applicable to the power storage device 10 distributed in homes, for example.

The load 40 consumes the power generated by the generation module 20, the power stored in the battery 110, or the power supplied from the electric power system 30, and may be, for example, homes, factories or other facilities.

The power storage device 10 stores the power supplied from the generation module 20 or the electric power system 30 and supplies the stored power to the electric power system 30 or the load 40. The power storage device 10 includes a battery managing unit 120, a two-way converter 130, a two-way inverter 140, a first switch 150, a second switch 160, a power converter 170, an integrated controller 180, and a voltage stabilizer 190. The battery 110 may be integrated with the power storage device 10 or may be detachably mounted thereon.

The battery 110 stores the power supplied from the generation module 20 or the electric power system 30. Operations of the battery 110 are controlled by the battery managing unit 120. The battery 110 may be realized using various types of battery cells, and may be, for example, a nickel-cadmium battery, a lead storage battery, a nickel metal hydride battery (NiMH), a lithium ion battery, a lithium polymer battery, a metal lithium battery, or a zinc-air battery. The number of battery cells included in the battery 110 may be determined by power capacity or design conditions that are required by the power storage device 10.

The battery managing unit 120 is connected to the battery 10 and controls charging or discharging operations of the battery 110. Input and output of a discharging current from the battery 110 to the two-way converter 130 and input and output of a charging current from the two-way converter 130 to the battery 110 are controlled by the battery managing unit 120. Also, to protect the battery 110, the battery managing unit 120 may perform functions such as over-charging protection, over-discharging protection, over-current protection, over-voltage protection, overheat protection, cell balancing, or the like. To this end, the battery managing unit 120 may monitor a voltage, a current, a temperature, a residual amount of power, or a lifespan of the battery 110.

The two-way converter 130 DC-DC converts a voltage level of power output from the battery 110 to a voltage level that is required by the two-way inverter 140, that is, a DC voltage level of the first node N1, and DC-DC converts a voltage level of charging power received through the first node N1 to a voltage level required by the battery 110. The charging power is supplied from the generation module 20 and may be power, a voltage level of which is converted by the power converter 170 or power supplied from the electric power system 30 through the two-way inverter 140. For example, when a voltage level of the first node N1 is a 380V DC, and a voltage level required by the battery 110 is a 100V DC, a voltage level of the charging power from the first node N1 is converted from 380V DC to 100V DC when charging the battery 110, and when discharging the battery 110, a voltage level of the discharging power is converted from 100V DC to 380V DC.

The two-way inverter 140 rectifies an AC voltage that is input from the electric power system 30 through the first switch 150 and the second switch 160, to a DC voltage for storing the AC voltage in the battery 110 and outputs the DC voltage, and converts the DC voltage output from the generation module 20 or the battery 110 to an AC voltage of the electric power system 30 and outputs the AC voltage. The AC voltage output to the electric power system 30 needs to correspond to the power quality standards of the electric power system 30, for example, a power factor of 0.9 or greater and a total harmonic distortion (THD) of 5% or less. To this end, the two-way inverter 140 synchronizes a phase of the output AC voltage with a phase of the electric power system 30 to suppress invalid power generation and needs to adjust a level of the AC voltage. Also, the two-way inverter 140 may include a filter for removing high frequencies from an AC voltage that is output from the electric power system 30, and may perform functions such as restriction of a voltage variation range, power factor improvement, removal of a DC component, protection from transient phenomena, or the like.

The first switch 150 and the second switch 160 are serially connected between the two-way inverter 140 and the electric power system 30 to control a current flow between the power storage device 10 and the electric power system 30. When there is no problem in the electric power system 30, the first switch 150 is turned on, and the second switch 160 is also turned on, thereby supplying power generated by the generation module 20 or the power stored in the battery 110 to the load 40 or the electric power system 30 or supplying the power from the generation module 20 to the power storage device 10. According to circumstances, the first switch 150 may be turned off, and the second switch 160 may be turned on so as to supply the power generated by the generation module 20 to the battery 110 and supply the power from the electric power system 30 to the load 40. When the electric power system 30 is not in a normal state, to prevent a stand alone operation, the first switch 150 is turned on, and the second switch 160 is turned off, thereby preventing the power from being supplied from the power storage device 10 to the electric power system 30, and supplying the power from the power storage device 10 and/or the generation module 20 to the load 40. The first switch 150 and the second switch 160 may be various types of switching devices, and may be, for example, a field effect transistor (FET) or a bipolar junction transistor (BJT). Switching operations of the first switch 150 and the second switch 160 may be controlled by the integrated controller 180.

The power converter 170 converts a voltage level of the power generated by the generation module 20 to a DC voltage of the first node N1. The operation of the power converter 170 may vary according to the type of the generation module 20. If the generation module 20 is a wind power generation module or a tidal power generation module that outputs an AC voltage, the power converter 170 AC-DC converts an AC voltage of the generation module 20 to a DC voltage of the first node N1, and if the generation module 20 is a solar battery 21 that outputs a DC voltage, the power converter 170 converts a DC voltage of the generation module 20 to a DC voltage of the first node N1. Also, if the generation module 20 is the solar battery 21, the power converter 170 converts a DC voltage output from the solar battery to a DC voltage of the first node N1, and may be a maximum power point tracker (MPPT) converter that uses MPPT algorithms for tracking a maximum power output voltage according to changes in, for example, solar irradiance, temperature, or the like.

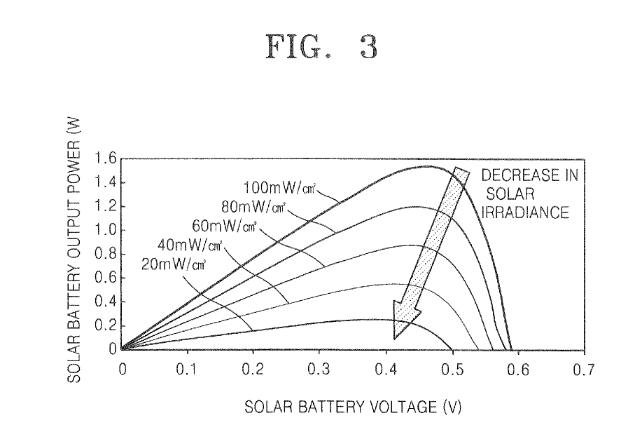

FIG. 3 is a graph illustrating a relationship between a solar battery voltage and a solar battery output power according to solar irradiance.

Referring to FIG. 3, an output of the solar battery 21 has non-linear characteristics in that I-V characteristics representing a state of an operational voltage and a current of the solar battery 21 that varies according to environmental factors such as solar irradiance or surface temperature. When operational points on a voltage-current curve of the I-V characteristics of the solar battery 21 are determined, the solar battery output power is determined accordingly, as is shown in FIG. 3. The MPPT algorithms are algorithms that track a maximum power output voltage so as to maximize usage of the power generated by the solar battery 21. Also, the MPPT algorithms may include a ride-through method for improving the power quality of the solar battery 21 by compensating for instantaneous voltage sag.

The integrated controller 180 monitors states of elements in the power storage device 10, the generation module 20, the electric power system 30, and the load 40 to control operations of the battery managing unit 120, the two-way converter 130, the two-way inverter 140, the first switch 150, the second switch 160, and the power converter 170.

The voltage stabilizer 190 stabilizes a DC voltage level of the first node N1 by maintaining it at a DC link level. The voltage level of the first node N1 may become unstable due to instantaneous voltage sag of the generation module 20 or the electric power system 30 or a peak load generated in the load 40. The voltage of the first node N1 needs however, to be stabilized for a normal operation of the two-way converter 130 and the two-way inverter 140. Accordingly, in order to stabilize the DC voltage level of the first node N1, the voltage stabilizer 190 may be included, and the voltage stabilizer 190 may be, for example, an aluminum electrolytic capacitor, a film capacitor for high pressure, or a multi-layer ceramic capacitor (MLCC) for a high voltage and a large current. In FIG. 1, the voltage stabilizer 190 is shown as separately included, but the voltage stabilizer 190 may also be integrated with the two-way converter 130, with the two-way inverter 140 or with the power converter 170.

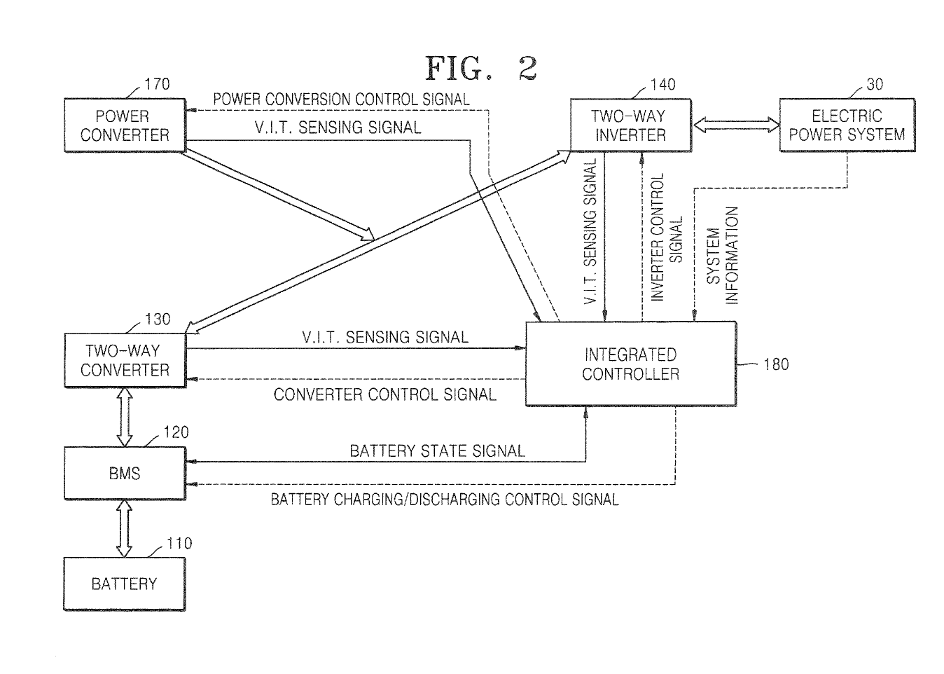

FIG. 2 is a flowchart illustrating power and a control signal of the energy storage system 100 of FIG. 1.

Referring to FIG. 2, power control between the elements of the energy storage system 100 of FIG. 1 and control flow of the integrated controller 180 are illustrated. Referring to FIG. 2, a DC voltage converted by the power converter 170 is supplied to the two-way inverter 140 and the two-way converter 130, and the supplied DC voltage is converted to an AC voltage by the two-way inverter 140 and supplied to the electric power system 30 or converted to a DC voltage to be stored in the battery 110 by the two-way converter 130 and is charged in the battery 110 via the battery managing unit 120. The DC voltage charged in the battery 110 is converted to an input DC voltage level in the two-way inverter 140 by the two-way converter 130, and is converted by the two-way inverter 140 to an AC voltage that satisfies the standards of the electric power system 30 and is supplied to the electric power system 30.

The integrated controller 180 controls the overall operation of the energy storage system 100 and determines an operational mode of the energy storage system 100, for example, whether to supply the generated power to the electric power system 30, to the load 40, or to the battery 110, or whether to store the power supplied from the electric power system 30 in the battery 110 or not.

The integrated controller 180 transmits a control signal for controlling switching operations of the power converter 170, the two-way inverter 140, and the two-way converter 130. The control signal minimizes loss due to power conversion of the two-way converter 130 or the two-way inverter 140 through optimum control of a duty ratio according to an input voltage of the two-way converter 130 or the two-way inverter 140. To this end, the integrated controller 180 receives signals indicating that a voltage, a current, or a temperature has been sensed, from an input terminal of each of the power converter 170, the two-way inverter 140, and the two-way converter 130, and transmits a converter control signal, an inverter control signal, and a power conversion control signal based on the sensing signal.

The integrated controller 180 receives information according to system conditions or system information including a voltage, a current, or a temperature of the electric power system 30 from the electric power system 30. The integrated controller 180 determines whether there is any problem in the electric power system 30 or whether the power has been restored, and blocks the power supply to the electric power system 30, and controls matching of the output of the two-way inverter 140 and the supplied power of the electric power system 30 to thereby prevent a stand alone operation of the electric power system 30.

The integrated controller 180 receives a battery state signal, that is, a charging/discharging state signal for the battery 110, through communication with the battery to managing unit 120, and determines an operational mode for the energy storage system 100 based thereon. Also, the charging/discharging state signal of the battery 110 is transmitted to the battery managing unit 120 according to the operational mode, and the battery managing unit 120 controls charging/discharging of the battery 110 according to the charging/discharging state signal.

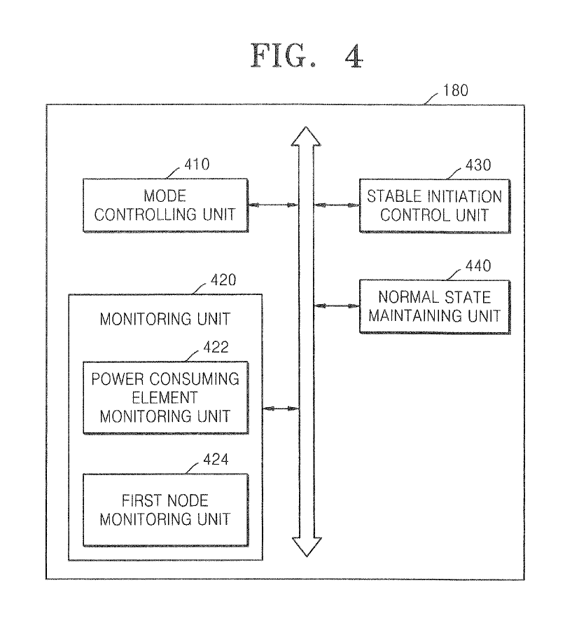

FIG. 4 is a schematic view illustrating the integrated controller 180 constructed according to the principles of the present invention.

Referring to FIG. 4, energy storage system 100 transfers power among components thereof via a first node N1. The power supply source supplies power to the first node N1, and the power consuming element receives power from the first node N1.

The operational mode of the energy storage system 100 may be changed due to a change in the power supply source or the power consuming elements. When the operational mode of the energy storage system 100 is changed, due to a change in the power supply source or in the consuming elements, undershoot or overshoot may occur in a voltage across the first node N1. The first node N1 is connected to the two-way converter 130, the two-way inverter 140, and the power converter 170, and thus if the voltage across the first node N1 is not stable, elements in the two-way converter 130, the two-way inverter 140, and the power converter 170 may be damaged or may not operate normally. Also, when the power supply source has changed due to the change in the operational mode of the energy storage system 100, and if a new power supply source rapidly increases the output power, an inrush voltage is output to the first node N1, and thus the elements of the energy storage system 100 that receive power from the first node N1 may be damaged.

Also, when a power consumption amount or a state of the power consuming element varies, and thus the output power of the power supply source changes in response to the change, undershoot or overshoot may occur in the first node N1.

Accordingly, when the operational mode of the energy storage system 100 is converted or when the state of the power consuming element varies, the rate of variation of the output power of the power supply source is restricted to a restriction value or less to thereby prevent undershoot or overshoot at the first node N1 and prevent an inrush voltage being input to the elements that receive power from the first node N1. Accordingly, the elements of the energy storage system 100 connected to the first node N1, that is, the devices in the two-way converter 130, the two-way inverter 140, and the power converter 170 are protected, and the operation of the energy storage system 100 may be stably controlled. The restriction value may be determined in advance.

The integrated controller 180 includes a mode controlling unit 410, a monitoring unit 420, a stable initiation control unit 430, and a normal state maintaining unit 440.

The mode controlling unit 410 controls an operational mode of the energy storage system 100 based on states of the elements of the energy storage system 100 that are monitored by the monitoring unit 420. Operations that may be performed in the energy storage system 100 may be the following:

storing power generated by the generation module 20 in the battery 110;

storing power supplied from the electric power system 30 in the battery 110;

selling the power generated by the generation module 20 to an electric power system 30;

selling the power stored in the battery 110 to the electric power system 30;

supplying the power generated by the generation module 20 to the load 40;

supplying the power stored in the battery 110 to the load 40;

supplying the power supplied from the electric power system 30 to the load 40; and

blocking the power supply to the electric power system 30 if the electric power system 30 is not in a normal state.

These operations may be performed individually or at the same time (simultaneously), and the operational mode of the energy storage system 100 may be defined according to the operations being performed. The mode controlling unit 410 controls operations of the battery managing unit 120, the two-way converter 130, the two-way inverter 140, the first switch 150, the second switch 160, and the power converter 170 in each operational mode. Also, the mode controlling unit 410 may output a control signal to each of the elements of the energy storage system 100 as has been described above with reference to FIG. 2.

The monitoring unit 420 monitors states of the elements of the energy storage system 100. To this end, the monitoring unit 420 receives a battery state signal from the battery managing unit 120 as described with reference to FIG. 2, and may sense a voltage, a current, a temperature or the like for the two-way converter 130 from the two-way converter 130, may sense a voltage, a current, or a temperature of the two-way inverter 140 from the two-way inverter 140, and sense a voltage, a current, or a temperature from the power converter 170, and may receive system information from the electric power system 30. According to the current embodiment of the present invention, the monitoring unit 420 may monitor the output power of the two-way converter 130, the two-way inverter 140, and the power converter 170 that output power across the first node N1.

The monitoring unit 420 includes a power consuming element monitoring unit 422 and a first node monitoring unit 424.

The power consuming element monitoring unit 422 monitors a state of a power consuming element in a current operational mode. For example, when supplying power to the load 40, the power consuming element monitoring unit 422 monitors a power consumption amount of the load 40 and makes a determination about whether a peak load has been generated. According to another example, when selling power to the electric power system 30, the power consuming element monitoring unit 422 monitors whether the electric power system 30 is in a normal state, and makes a determination about a power selling amount. Also, when charging power to the battery 110, the power consuming element monitoring unit 422 monitors a state and a charging current of the battery 110.

The first node monitoring unit 424 monitors a voltage level and a current at the first node N1.

The stable initiation control unit 430 restricts an output power variation rate of a power supply source to a restriction value, or less, when an operational mode of the energy storage system 100 is changed by the mode controlling unit 410 or when a change in the state of the power consuming element is sensed by the power consuming element monitoring unit 422. A period in which an output current variation rate of the power supply source is restricted by the stable initiation control unit 430 may be extended until the first node N1 reaches a normal state. According to another example, a period in which an output current variation rate of the power supply source is restricted to be a restriction value or less by the stable initiation control unit 430 may be a time period that is determined in advance. Also, the output current variation rate of the power supply source may be restricted by the stable initiation control unit 430 by maintaining an output power variation rate to be a value that is determined in advance. According to another example, the output current variation rate of the power supply source may be restricted by the stable initiation control unit 430 by restricting the output power variation rate if the output power variation rate of the power supply source rises to, or beyond, a value that is determined in advance. In FIG. 4, the period, in which the output power variation rate is restricted by the stable initiation control unit 430, is until the first node N1 reaches a normal state.

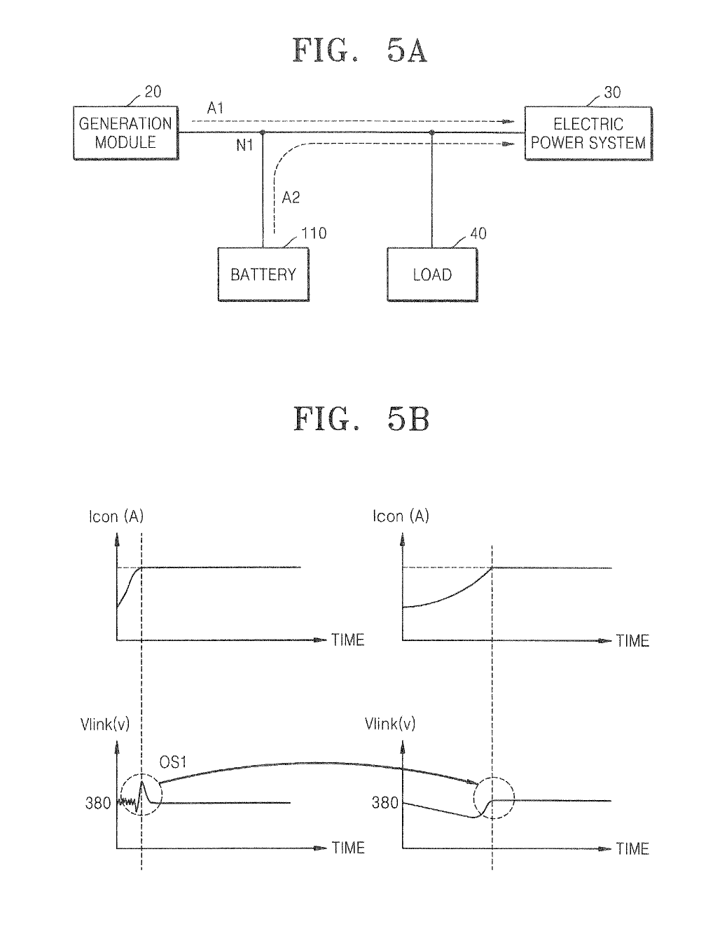

FIGS. 5A and 5B are schematic views illustrating an operational mode conversion of the energy storage system 100 according to the principles of the present invention.

FIG. 5A illustrates a case where an operational mode of the energy storage system 100 is changed from a 1-1 mode (A1) in which power generated by the generation module 20 is supplied to the electric power system 30 into a 1-2 mode (A2) in which power stored in the battery 110 is sold to the electric power system 30. When the operational mode is changed as described above, the power supply source is changed from the generation module 20 to the battery 110, and an element for outputting the power to the first node N1 is changed from the power converter 170 to the two-way converter 130. In this ease, if an output current of the two-way converter 130 is not restricted, as shown in a lower left graph of FIG. 5B, a first overshoot OS1 occurs at a voltage Vlink of the first node N1. According to the current embodiment of the present invention and as is shown in an upper right graph of FIG. 5B, the output current of the two-way converter 130 is gradually increased, thereby mitigating the overshoot OS1 at the first node N1. Also, according to the current embodiment, even when undershoot occurs due to a gradual increase in the output current of the two-way converter 130, the overshoot may be avoided, which is effective in preventing damage of the energy storage system 100. For example, when the output current of the two-way converter 130 is gradually increased, a rate at which the output current of the two-way converter 130 increases may be adjusted so as to prevent the energy storage system 100 from being turned off due to the undershoot.

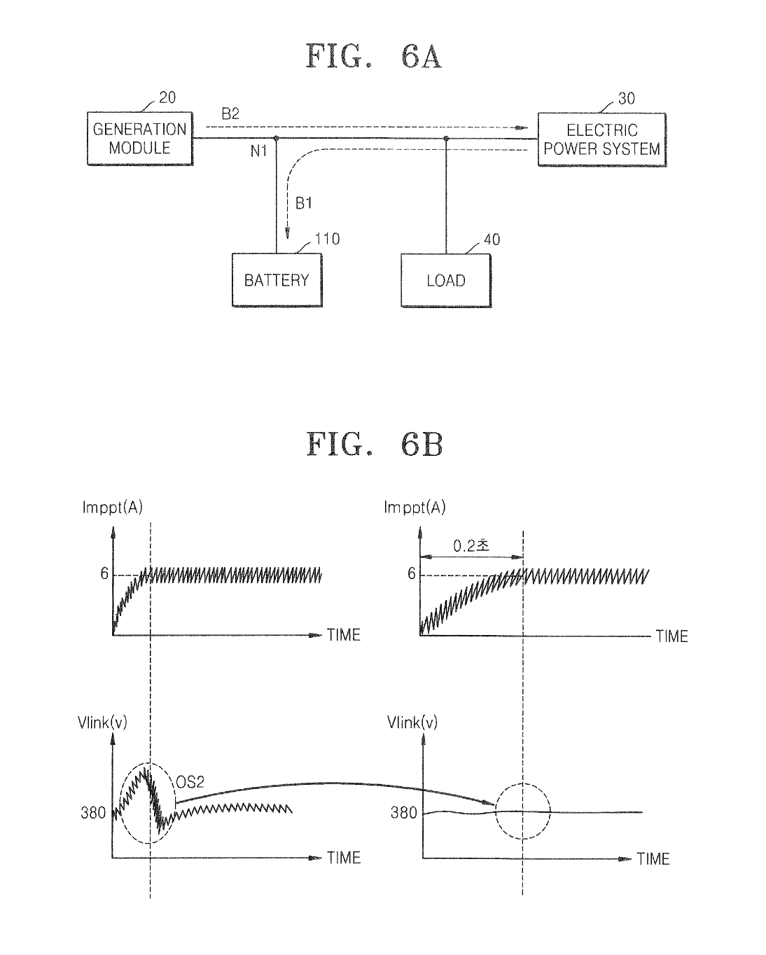

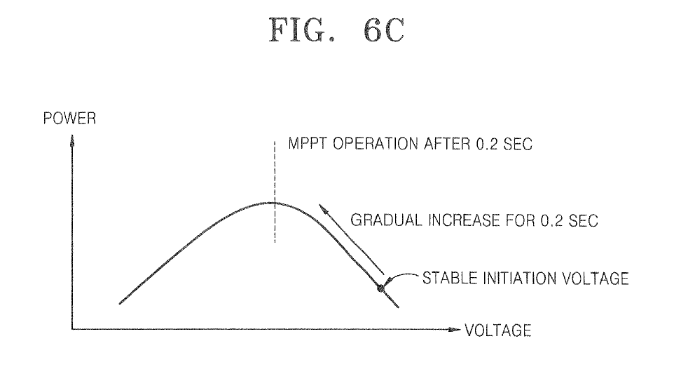

FIGS. 6A through 6C are schematic views illustrating an operational mode conversion of the energy storage system 100 according to the principles of the present invention.

FIG. 6A illustrates a case where an operational mode of the energy storage system 100 is changed from a 2-1 mode (B1) in which power supplied from the electric power system 30 is stored in the battery 110 to a 2-2 mode (B2) in which power generated by the generation module 20 is sold to the electric power system 30. When the operational mode of the energy storage system 100 is changed as described above, the power supply source is changed from the generation module 20 to the electric power system 30, and an element for outputting the power to the first node N1 is changed from the two-way inverter 140 to the power converter 170. In this case, if the output power of the power converter 170 is not restricted, as shown in a lower left graph of FIG. 6B, second overshoot OS2 occurs at a voltage Vlink of the first node N1. According to the current embodiment, as shown in an upper right graph of FIG. 6B, the output current Imppt of the power converter 170 is gradually increased, thereby mitigating the overshoot OS2 at the first node N1.

For example, if the generation module 20 is the solar battery 21 and the power converter 170 is a MPPT converter, the stable initiation control unit 430 constructed and operating according to the principles of the present invention does not have to perform the MPPT algorithms during a time period that has been determined in advance, but instead controls an operational voltage of the MPPT converter to slowly increase from a stable initiation voltage as shown in FIG. 6C. Accordingly, according to the control by the stable initiation control unit 430, the MPPT converter 170 gradually increases an output current Imppt during a time period that has been determined in advance, and the second overshoot OS2 at the first node N1 is mitigated accordingly.

When the voltage of the first node N1 reaches a normal state, the normal state maintaining unit 440 controls the elements of the energy storage system 100 so as to maintain a power supply amount to the first node N1 in the normal state. For example, when the power supply source is changed to the battery 110, and when the voltage of the first node N1 reaches a normal state, the normal state maintaining unit 440 maintains the output power of the two-way converter 130 in the normal state. According to another example, when the power supply source is changed to the generation module 20, the normal state maintaining unit 440 controls the power converter 170 to perform MPPT algorithms when the voltage of the first node N1 reaches a normal state.

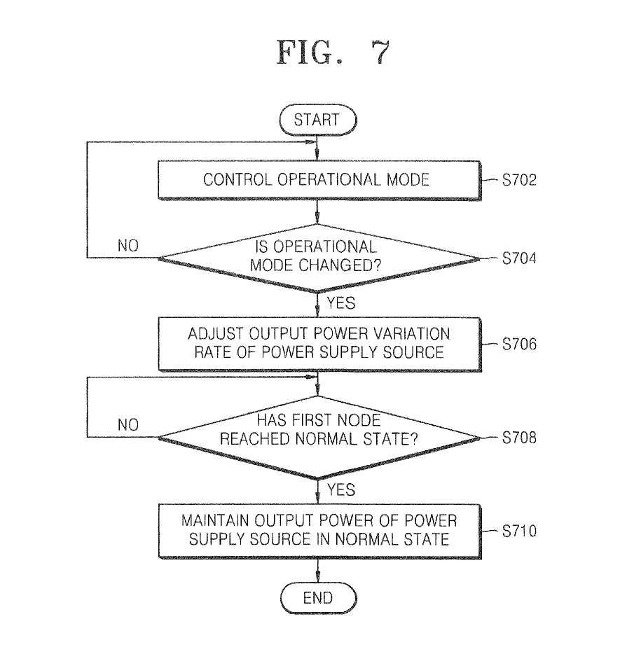

FIG. 7 is a flowchart illustrating a method of controlling the energy storage system 100 with an embodiment of the present invention.

According to the method of controlling the energy storage system 100, first, an operational mode of the energy storage system 100 is controlled in operation S702. The elements of the energy storage system 100 are controlled according to the operational mode. When the operational mode of the energy storage system 100 is changed in operation S704, an output power variation rate of the power supply source of the first node N1 is adjusted in operation S706. For example, the output power variation rate of the two-way converter 130, the two-way inverter 140 or the power converter 170 may be adjusted. A period in which the output power variation rate of the power supply source is restricted to a restriction value or less may be until the first node N1 reaches a normal state. According to another example, a period in which an output current variation rate of the power supply source is restricted to a restriction value or less may be a time period that is determined in advance. Also, the output current variation rate of the power supply source may be restricted by maintaining an output power variation rate to be a value that has been determined in advance. According to another example, the output current variation rate of the power supply source may be restricted by restricting the output power variation rate if the output power variation rate of the power supply source rises to or beyond a value that is determined in advance. In FIG. 7, the period in which the output power variation rate is restricted is extended until the first node N1 reaches a normal state.

According to the method of controlling the energy storage system 100, when the first node N1 reaches a normal state in operation S708, the output power of the elements that supply power to the first node N1 are controlled to maintain a normal state in operation S710. For example, due to the change in the operational mode, the power converter 170 outputs power to the first node N1, and if the power converter 170 is an MPPT converter and the first node N1 reaches a normal state, the power converter 170 is controlled to track a maximum power output voltage according to the MPPT algorithms.

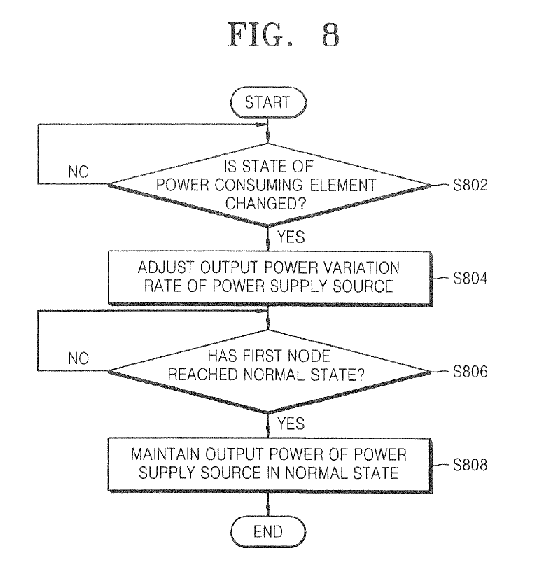

FIG. 8 is a flowchart illustrating a method of controlling the energy storage system 100 with another embodiment of the present invention.

According to the current embodiment, when a state of a power consuming element of the energy storage system 100 is changed, an output power variation rate of an element for outputting power to the first node N1 is adjusted.

First, in operation S802, whether the state of the power consuming element is changed is determined. For example, when power is supplied to the load 40, whether a power consumption amount of the load 40 is abruptly changed or whether a peak load is generated is determined. According to another example, when the power is sold to the electric power system 30, whether the electric power system 30 is not in a normal state due to a blackout generated in the electric power system 30 is determined.

When a change in the state of the power consuming element is detected in operation S802, an output power variation rate of the element for outputting power to the first node N1 is adjusted in operation S804. For example, when a peak load is generated in the load 40, an output power variation rate of the power converter 170 or the two-way converter 130 that supplies power to the load 40 is restricted to be a restriction value or to a lesser value. According to another example, when power is supplied from the generation module 20 or the battery 110 to the electric power system 30 and the load 40 and then a blackout is generated in the electric power system 30 and thus selling of the power is stopped and the power is supplied only to the load 40, an output power decrease rate of the power converter 170 or the two-way converter 130 is restricted to be a restriction value or less, thereby preventing undershoot at the first node N1.

Next, when the first node N1 reaches a normal state in operation S806, an output power of the element that applies electrical power to the first node N1 is maintained in a normal state in operation S808.

According to embodiments of the present invention, when the operational mode of the energy storage system is converted or when the state of the power consuming element is changed, an output power variation rate of a power supply source of the first node is restricted, thereby minimizing generation of an undershoot or an overshoot of the first node.

While the present invention has been particularly shown and described with reference to exemplary embodiments thereof, it will be understood by those of ordinary skill in the art that various changes in form and details may be therein without departing from the spirit and scope of the invention as defined by the appended claims. The exemplary embodiments should be considered in a descriptive sense only, and not for purposes of limitation. Therefore, the scope of the invention is defined not by the detailed description of the invention but by the appended claims, and all differences within the scope will be construed as being included in the present invention.

What is claimed is:

1. An energy storage system, comprising:
a power converter that converts electrical power supplied from a generation module to a first voltage and outputs the first voltage to a first node;
a battery that receives electrical power from the generation module or an electric power system to charge the battery and discharges the power to the electric power system or a load;
a two-way converter that converts a voltage level of the power stored in the battery to the first voltage and outputs the power converted in the two-way converter, and converts the voltage level of the power input from the first node to output the power to the battery;
a two-way inverter that inverts the power output from the electric power system to the first voltage and outputs the first voltage to the first node, and inverts the power input from the first node to output the power to the load or the electric power system; and
an integrated controller that controls operations of the power converter, the battery, the two-way converter, and the two-way inverter,
wherein when an operational mode of the energy storage system is converted, the integrated controller restricts an output power variation rate of at least one of the power converter, the two-way converter, and the two-way inverter.

2. The energy storage system of claim 1, wherein the integrated controller comprises:
a mode controlling unit that controls an operational mode of the energy storage system; and
a stable initiation control unit that restricts, when a power supply element to the first node is changed according to a change in the operational mode of the energy storage system, an output power variation rate of a new power supply element to be a restriction value or less.

3. The energy storage system of claim 1, wherein the integrated controller comprises:
a power consuming element monitoring unit that senses a change in a power consuming element that receives power through the first node or a change in a state of the power consuming element; and
a stable initiation control unit that restricts, when a power supply element is changed or when a change in the state of the power consuming element is sensed, an output power variation rate of a new power supply element to be a restriction value or less.

4. The energy storage system of claim 1, wherein the integrated controller comprises:
a first node monitoring unit that senses a voltage of the first node; and
a normal state maintaining unit that maintains a power supply of a power supply element of the first node in a normal state when the voltage of the first node reaches a normal state voltage.

5. The energy storage system of claim 1, wherein the integrated controller restricts an output power variation rate of a power supply element of the first node in a time period that is determined in advance.

6. The energy storage system of claim 1, wherein the integrated controller maintains the output power variation rate to be a value that is determined in advance when restricting the output power variation rate.

7. The energy storage system of claim 1, wherein the integrated controller controls the power supply element of the first node so as to reduce the output power variation rate when the output power variation rate rises to or beyond a value determined in advance when restricting the output power variation rate.

8. The energy storage system of claim 1, wherein when the battery is initially applied across the first node as a new power supply source, the integrated controller controls at least one of the battery and the two-way converter so as to restrict a variation rate of an output current that is output from the two-way converter to the first node.

9. The energy storage system of claim 1, wherein when the electric power system is initially applied across the first node as a new power supply source, the integrated controller controls the two-way inverter to restrict a variation rate of an output current that is output to the first node through the two-way inverter from the electric power system.

10. The energy storage system of claim 1, wherein the generation module is a solar battery, and the power converter is a maximum power point track (MPPT) converter, and when the solar battery is initially applied as a new power supply source, the integrated controller controls the MPPT converter to restrict an operational voltage variation rate of the MPPT converter, and when the first node reaches a normal state, the integrated controller controls the MPPT converter to track a maximum power output voltage.

11. The energy storage system of claim 1, wherein the battery is detachably mounted to the energy storage system.

12. A method of controlling an energy storage system, wherein the energy storage system supplies electrical power that is supplied from a generation module to a battery, a load, or an electric power system via a first node, and supplies the power charged to the battery to the load or the electric power system via the first node, and supplies the power supplied from the electric power system to the load or the battery via the first node, the method comprising:
controlling an operational mode of the energy storage system; and
restricting an output power variation rate of a power supply source of the first node when the operational mode of the energy storage system is changed.

13. The method of claim 12 further comprising; restricting an output power variation rate of a new power supply element to be a restriction value or less when a power supply element to the first node is changed according to a change in the operational mode of the energy storage system.

14. The method of claim 12, further comprising:
monitoring a change in a power consuming element that receives power via the first node or a change in a state of the power consuming element; and
restricting an output power variation rate of the power supply element of the first node to be the restriction value or less when the power consuming element is changed or when a change in the state of the power consuming element is sensed.

15. The method of claim 12, further comprising;
monitoring the first node in which a voltage of the first node is sensed, and in the restricting of the output power variation rate, a power supply of the power supply element of the first node is maintained in a normal state.

16. The method of claim 12, wherein the restricting of the output power variation rate comprises restricting the output power variation rate of the power supply element of the first node in a time period that is determined in advance.

17. The method of claim 12, wherein the restricting of the output power variation rate comprises maintaining the output power variation rate at a value that is determined in advance.

18. The method of claim 12, wherein the restricting of the output power variation rate comprises controlling the output power variation rate to decrease when the output power variation rate rises to or beyond a value that is determined in advance.

19. The method of claim 12, wherein in the restricting of the output power variation rate, when the battery is initially applied as a new power supply source across the first node, one of the battery and the two-way converter that converts a voltage level of a current output from the battery is controlled so as to restrict a variation rate of the output current that is output from the battery to the first node.

20. The method of claim 12, wherein in the restricting of the output power variation rate, when the electric power system is initially applied as a new power supply source, a variation rate of an output current that is output from the electric power system to the first node is controlled to be restricted.

21. The method of claim 12, wherein the generation module is a solar battery, and power output from the solar battery is converted by a maximum power point track (MPPT) converter and is output to the first node, and in the restricting of the output power variation rate, when the solar battery is initially applied as a new power supply source, an operational voltage variation rate of the MPPT converter is restricted, and when the first node reaches a normal state, the MPPT converter is controlled so as to track a maximum power output voltage.
